(19) United States
(12) Patent Application Publication
(10) Pub. No.: US 2023/0104770 A1
(43) Pub. Date: Apr. 6, 2023

(54) Cube Fuse Adapter

(71) Applicant: Wöhner Besitz GmbH, Rodental (DE)

(72) Inventor: Philipp Steinberger, Coburg (DE)

(21) Appl. No.: 17/495,361

(22) Filed: Oct. 6, 2021

(51) Int. Cl. H01R 13/688; H01R 31/06; H01H 85/20

(52) U.S. Cl. CPC H01R 13/688; H01R 31/06; H01H 85/205

(57) ABSTRACT

A cube fuse adapter (1) comprising an adapter housing (2) shaped in the form of a cube fuse and including a pair of fuse reception contacts (4-1, 4-2) provided to receive a cylindrical fuse (5), wherein both fuse reception contacts (4-1, 4-2) are connected to associated electrical contacts (3-1, 3-2) protruding from a bottom side of the adapter housing (2) of said cube fuse adapter (1).

### TECHNICAL FIELD

The invention relates to a cube fuse adapter for a cylindrical fuse.

### BACKGROUND

Cylindrical fuses are widely used and have metallic contacts at the end faces thereof. Cylindrical fuses do not comprise laterally protruding contacts but have at both ends metallic contact caps. Cylindrical fuses can comprise class J fuses with current ratings up to 60 Amps. In contrast to cylindrical fuses, cube fuses such as CF fuses according to UL 248-17, which are also referred to as cube fuses, are finger-safe and are integrated in a cubic housing made of a fire resistant plastic material having protruding electrical contacts. Current ratings of a conventional cube fuses can be in a range of up to 400 A.

Since conventional cylindrical fuses, in particular class J cylindrical fuses, are not finger-safe, there is a need to provide a compact device which provides a finger-safe enclosure protection and which allows a compatible use of cylindrical fuses with cube fuses in a power distribution system.

### SUMMARY OF THE INVENTION

The invention provides a cube fuse adapter comprising an adapter housing shaped in the form of a cube fuse and including a pair of fuse reception contacts provided to receive a cylindrical fuse, wherein both fuse reception contacts are connected to associated electrical contacts protruding from a bottom side of the adapter housing of said cube fuse adapter or wherein each fuse reception contact of said pair of fuse reception contacts forms with an associated electrical contact and integral component.

In a possible embodiment of the cube fuse adapter according to the first aspect of the present invention, the cylindrical fuse comprises on both ends contact caps being insertable into U-shaped fuse reception contacts.

In an alternative embodiment of the cube fuse adapter according to the first aspect of the present invention the cylindrical fuse comprises on both ends contact caps having end surfaces pressed between fuse reception contacts.

In a further possible embodiment of the cube fuse adapter according to the first aspect of the present invention, each U-shaped fuse reception contact comprises two spaced apart contact arms facing each other and being connected to each other by means of a common contact base portion.

In a still further possible embodiment of the cube fuse adapter according to the first aspect of the present invention, the contact base portion of the U-shaped fuse reception contact is connected to an electrical contact protruding from the bottom side of the adapter housing of said cube fuse adapter or form a common integral component with the electrical contact.

In a possible embodiment of the cube fuse adapter according to
the first aspect of the present invention, the cylindrical fuse received by the cube fuse adapter comprises a class J fuse or a class CC fuse or a 14×51 fuse or a 22×58 fuse or a 10×38 fuse.

In a still further possible embodiment of the cube fuse adapter according to the first aspect of the present invention, the electrical contacts protruding from the bottom side of the adapter housing of said cube fuse adapter are pluggable into contact slots of a cube fuse holder or into contact slots of a cube fuse switch.

In a still further possible embodiment of the cube fuse adapter according to the first aspect of the present invention, the cube fuse adapter comprises an integrated light emitting diode and a resistor connected in series to the light emitting diode wherein the light emitting diode and the in serial connected resistor are connected in parallel to the cylindrical fuse inserted into the U-shaped fuse reception contacts. The light emitting diode is adapted to emit light to indicate an interruption of an electrical current flow after the cylindrical fuse has melted due to an overcurrent.

In a still further possible embodiment of the cube fuse adapter according to the first aspect of the present invention, the adapter housing of the cube fuse adapter comprises a cover portion being removable from a base portion at the bottom side of the adapter housing.

In a further possible embodiment of the cube fuse adapter according to the first aspect of the present invention, a cover portion and the base portion at the bottom side of the adapter housing comprise a fire resistant material and/or a heat conductive material.

In a still further possible embodiment of the cube fuse adapter according to the first aspect of the present invention, the pair of fuse reception contacts is pivotable around a rotation axis between a first position wherein an inserted cylindrical fuse is covered by the adapter housing and a second position where the inserted cylindrical fuse is replaceable.

In a further possible embodiment of the cube fuse adapter according to the first aspect of the present invention, the cylindrical fuse is inserted into the fuse reception contacts by pushing the cylindrical fuse through a reception opening within the adapter housing.

In a still further possible embodiment of the cube fuse adapter according to the first aspect of the present invention, the fuse reception contacts are externally sprung.

In a still further possible alternative embodiment of the cube fuse adapter according to the first aspect of the present invention, the fuse reception contacts are self-sprung.

In a further possible embodiment of the cube fuse adapter according to the first aspect of the present invention, the cylindrical fuse is insertable into a fuse holding element.

In a further possible embodiment of the cube fuse adapter according to the first aspect of the present invention, the fuse holding element containing the inserted cylindrical fuse is pivotable around a rotation axis or is movable between a first position where the fuse holding element is enclosed by the adapter housing and a second position where the fuse holding element are replaceable along with the inserted fuse.

In a further possible embodiment of the cube fuse adapter according to the first aspect of the present invention, the adapter housing provides at least an IP20 enclosure protection.

In a further possible embodiment of the cube fuse adapter according to the first aspect of the present invention, the adapter housing comprises ventilation slots to provide heat dissipation.

The invention provides according to a further aspect a power distribution system comprising at least one cube fuse adapter according to the first aspect of the present invention pluggable into contact slots of a cube fuse holder or into contact slots of a cube fuse switch of said power distribution system.

### BRIEF DESCRIPTION OF FIGURES

In the following, possible embodiments of the different aspects of the present invention are described in more detail with reference to the enclosed figures.

FIG. 1 shows a perspective view on a possible exemplary embodiment of a cube fuse adapter according to the present invention;

FIGS. 2A-2C show perspective views of a possible embodiment of a the cube fuse adapter illustrated in FIG. 1 with a removed cover portion;

FIGS. 3A-3D show perspective views of a further possible embodiment of a the cube fuse adapter illustrated in FIG. 1 with a removed cover portion;

FIGS. 4A-4B show perspective views of a further possible embodiment of a the cube fuse adapter illustrated in FIG. 1 with a removed cover portion;

FIG. 5 shows a cross section view through a cube fuse adapter according to the first aspect of the present invention;

FIG. 6 shows an arrangement where cube fuse adapters according to the present invention are plugged into a cube fuse holder;

FIG. 7 illustrates a circuit diagram of a possible exemplary embodiment of a cube fuse adapter according to the present invention.

### DETAILED DESCRIPTION

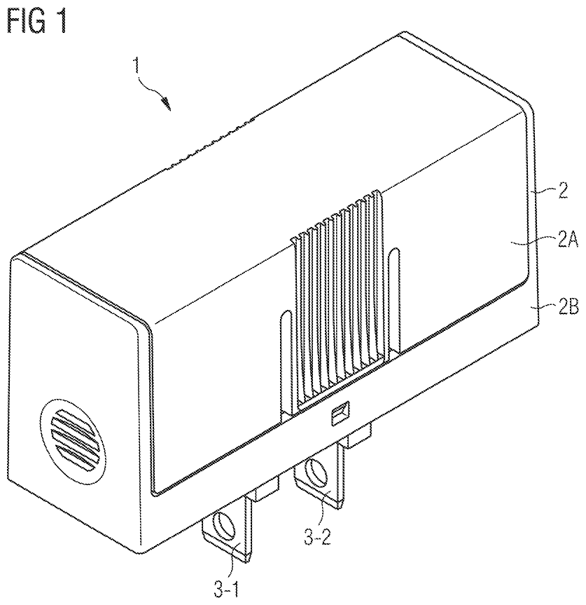

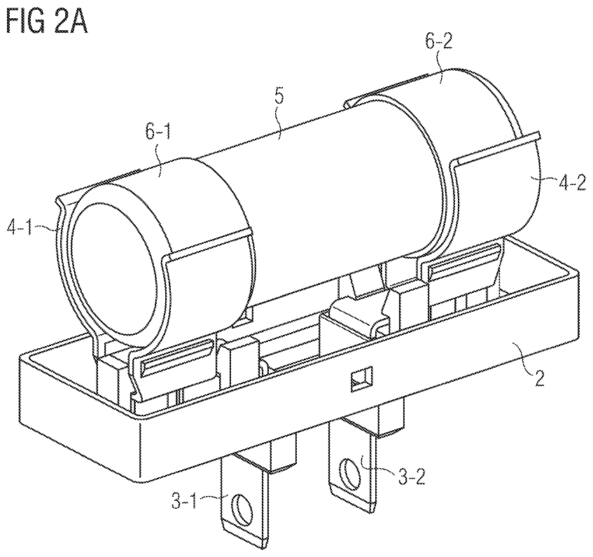

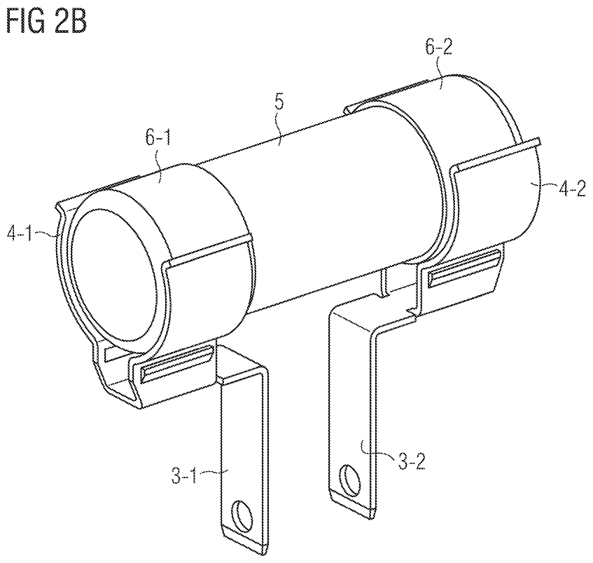

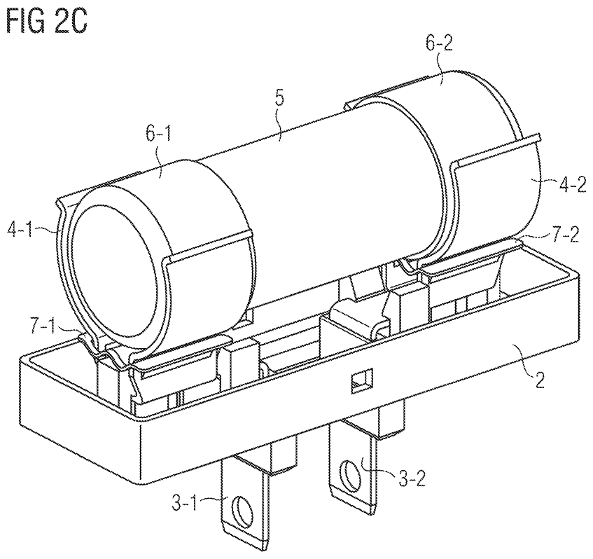

As can be seen from the perspective view illustrated in FIG. 1, a cube fuse adapter 1 according to the first aspect of the present invention comprises an adapter housing 2 shaped in the form of a cube fuse. The cube fuse housing 2 has at its bottom side protruding electrical contacts 3-1, 3-2 as illustrated in FIG. 1. The adapter housing 2 can comprise two portions, i.e. a cover portion 2A and a base portion 2B at a bottom side of the adapter housing 2.The adapter housing 2 has inside a reception chamber provided for reception of a cylindrical fuse 5. The reception chamber comprises fuse reception contacts 4-1, 4-2 for receiving and holding an inserted cylindrical fuse 5 mechanically and to establish an electrical contact between contact caps 6-1, 6-2 of the inserted cylindrical fuse 5 and the protruding contacts 3-1, 3-2. The fuse reception contacts 4-1,4-2 can have different shapes as described in context with the embodiments of FIGS. 2 to 5.

FIGS. 2A to FIG. 2D illustrate the cube fuse adapter 1 with a removed cover portion 2A. As can be seen from FIG. 2A, the electrical contacts 3-1, 3-2 protrude from the base portion 2B at the bottom side of the adapter housing 2 of the cube fuse adapter 1. The cover portion 2A of the adapter housing 2 as shown in FIG. 1 can be removed in a possible implementation manually from the base portion 2B. A user may use two fingers to press the opposite sidewalls of the cover portion 2A to disengage the cover portion 2A mechanically from the base portion 2B for inserting or replacing a cylindrical fuse within the cube fuse adapter 1. As can be seen in FIG. 2, the cube fuse adapter 1 comprises a pair of fuse reception contacts 4-1, 4-2 to receive a cylindrical fuse 5. The fuse reception contacts 4-1, 4-2 are connected electrically to the associated electrical contacts 3-1, 3-2 protruding from the bottom side of the adapter housing 2 of the cube fuse adapter 1. The first fuse reception contact 4-1 and the first electrical contact 3-1 as well as the second fuse reception contact 4-2 and the second electrical contact 3-2 can form in a possible embodiment an integral component as illustrated in FIG. 2B. As can be seen in FIG. 2, the cylindrical fuse 5 comprises on both ends metallic contact caps 6-1, 6-2 insertable into the fuse reception contacts 4-1, 4-2 as shown in FIGS. 2A-2C. The cylindrical fuse 5 can comprise in a possible embodiment a class J or a class CC fuse having a ceramic body with two electrical conductive contact caps 6-1, 6-2 on both ends as shown in FIG. 2. The electrical contacts 3-1, 3-2 protruding from the bottom side of the adapter housing 2 of the cube fuse adapter 1 are pluggable in a possible embodiment into corresponding contact slots of a cube fuse holder or into contact slots of another adapter or device such as a cube fuse switch. The protruding contact slots 3-1,3-3 can be plugged into corresponding contact slots of another device of a power distribution system. This device may comprise for instance a busbar board encompassing busbars with corresponding contact slots.

The cover portion 2A and the base portion 2B at the bottom portion of the adapter housing 2 comprise in a preferred embodiment a fire resistant material. The material of the cover portion 2A and the base portion 2B of the adapter housing 2 can in a possible embodiment be formed by a heat conductive material. The walls of the cover portion 2A of the adapter housing 2 can comprise at least partially transparent material allowing a user to see whether a cylindrical fuse 5 has been inserted into the fuse reception contacts 4-1,4-2. In the embodiment illustrated in FIGS. 1 to 5 the cover portion 2A of the adapter housing 2 can be removed by a user to insert a cylindrical fuse 5 into the fuse reception contacts 4-1, 4-2. After having inserted the cylindrical fuse 5 into the fuse reception contacts 4-1, 4-2, the user can put the cover portion 2A back onto the base portion 2B of the adapter housing 2. Each fuse reception contacts 4-1, 4-2 can be self-sprung or sprung by a separate associated spring component exerting a mechanical force on the respective fuse reception contact. In the embodiment shown in FIG. 2 the fuse reception contacts 4-1, 4-2 are sprung by disc springs 7-1, 7-2.

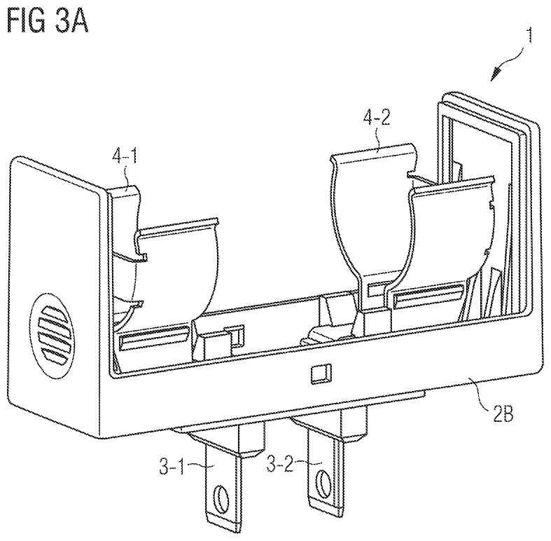

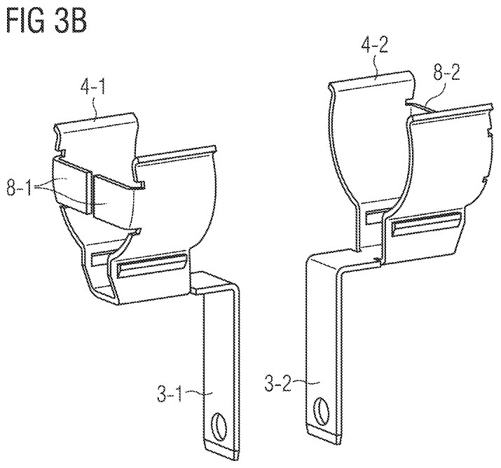

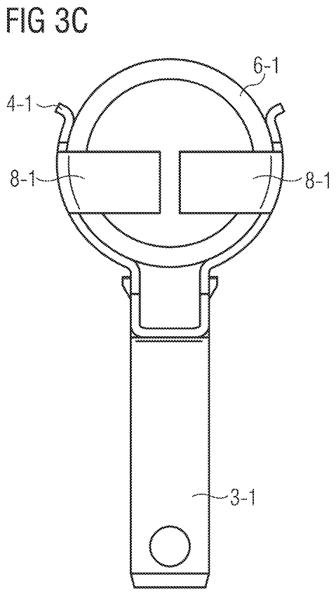

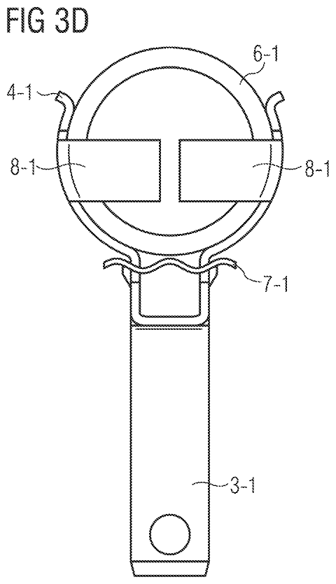

FIGS. 3A-3D show perspective views of a further possible embodiment of a cube fuse adapter 1 illustrated in FIG. 1 with a removed cover portion 2A. The fuse reception contacts 4-1, 4-2 are connected electrically to the associated electrical contacts 3-1, 3-2 protruding from the bottom side of the adapter housing 2 of the cube fuse adapter 1. The first fuse reception contact 4-1 and the first electrical contact 3-1 as well as the second fuse reception contact 4-2 and the second electrical contact 3-2 can form in a possible embodiment an integral component as illustrated in FIG. 3B where the base portion 2B is removed. As can be seen in FIGS. 3, the cylindrical fuse 5 comprises on both ends metallic contact caps 6-1, 6-2 insertable into the fuse reception contacts 4-1, 4-2. The cylindrical fuse 5 can comprise in a possible embodiment a class J or a class CC fuse having a ceramic body with two electrical conductive contact caps 6-1, 6-2 on both ends pressed between protruding contact portions 8-1,8-2 of the fuse reception contacts 4-1,4-2 as shown in FIGS. 3B,3C. Further dices springs 7-1,7-2 can also be provided as shown in FIG. 3D.

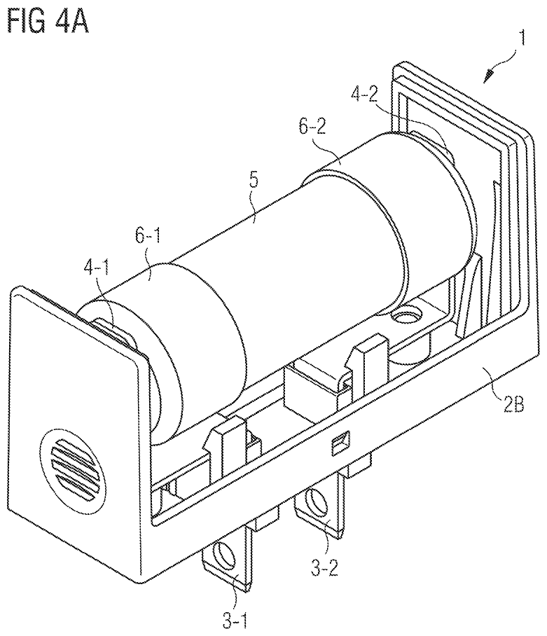

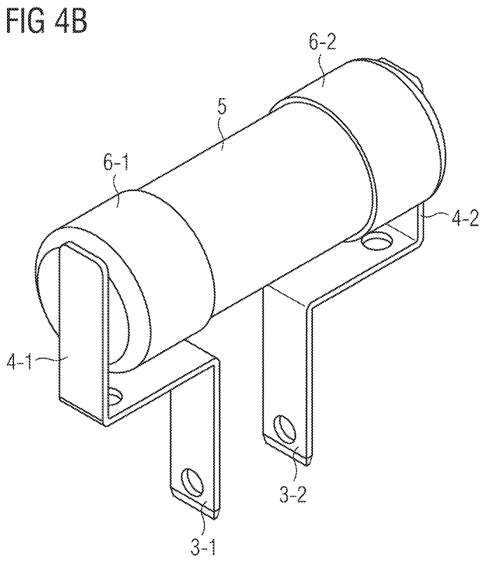

FIG. 4A and FIG. 4B show perspective views of a further possible embodiment of the cube fuse adapter 1 illustrated in FIG. 1 with a removed cover portion. In this embodiment the fuse reception contacts 4-1,4-2 are not U-shaped. The contact caps 6-1,6-2 are inserted between the distal reception contacts 4-1,4-2. FIG. 4B shows the adapter 1 with removed base portion 2B.

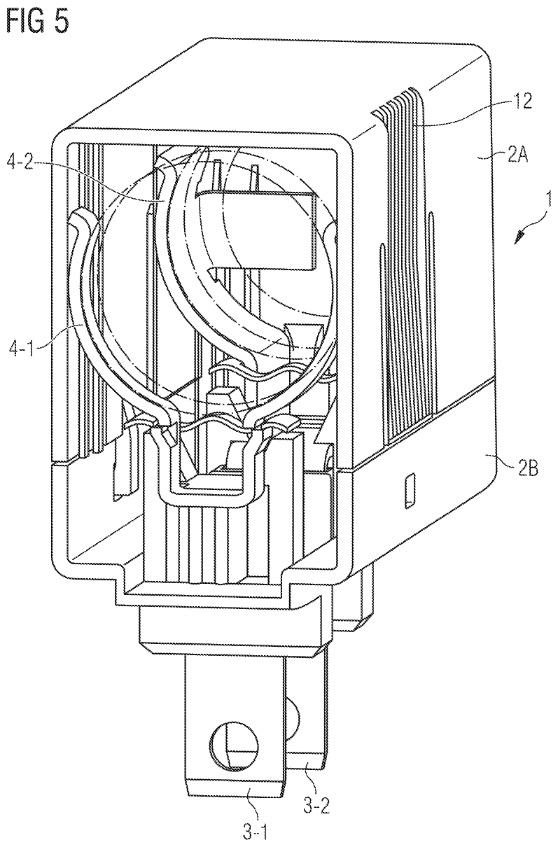

FIG. 5 shows a cross section view through a cube fuse adapter 1 as illustrated in FIGS. 1, 2. The fuse reception contacts 4-1, 4-2 are connected electrically to the electrical contacts 3-1, 3-2 protruding from the bottom side of the adapter housing 2. As can be seen from the embodiments of FIGS. 2, 3, the fuse reception contacts 4-1, 4-2 can be U-shaped to receive the cylindrical contact caps 6-1, 6-2 of a cylindrical fuse 5. As shown in FIG. 3B to FIG. 3D and in the cross section view of FIG. 5, each U-shaped fuse reception contact 4-1, 4-2 can comprise two spaced apart contact arms facing each other and being connected to each other by means of a contact base portion which is connected within the adapter housing 2 electrically to an associated protruding electrical contact 3-1, 3-2.

The cover portion 2A of the adapter housing 2 can comprise in a possible implementation side walls 12 having protruding engaging hooks adapted to engage into corresponding recesses of the base portion 2B. By pressing the slightly elastic sidewalls 12 of the cover portion 2A it is possible to disengage the locking hooks from the corresponding recesses provided in the bottom portion 2B of the adapter housing 2. After a user has pressed with the finger tips of his fingers against opposite side walls 8 of the cover portion 2A, a user can disengage the locking hooks cover portion 2A from the recesses of the base portion 2B to open the adapter housing 2 an to get access to the fuse reception contacts 4-1, 4-2 located inside of the adapter housing 2 of the cube fuse adapter 1. Other mechanical means to mechanically connect the base portion 2B with the cover portion 2A can be used as well.

For instance the cover portion 2A can be pivoted in a possible embodiment around a rotation axis at an edge of the base portion 2B.

After having removed the cover portion 2A, a user can insert the cylindrical fuse 5 with its contact caps 6-1, 6-2 into the corresponding fuse reception contacts 4-1, 4-2. After the insertion of the cylindrical fuse 5 has been accomplished, the user can place the cover portion 2A back onto the base portion 2B of the cube fuse adapter 1. In a further step, the user can then insert the cube fuse adapter 1 into another device, in particular into a cube fuse holder or into a cube fuse switch of a power distribution system. This can be achieved by plugging the protruding electrical contacts 3-1, 3-2 finger safe into corresponding contact slots of a cube fuse holder or of a cube fuse switch of the power distribution system as also illustrated in the arrangement of FIG. 4. The fuse reception contacts 4-1, 4-2 can be either externally sprung or self-sprung. The adapter housing 2 of the cube fuse adapter 1 provides at least an IP20 enclosure protection for a user, i.e. touch protection safety. In a possible embodiment, the adapter housing 2 can also comprise ventilation slots to provide improved heat dissipation.

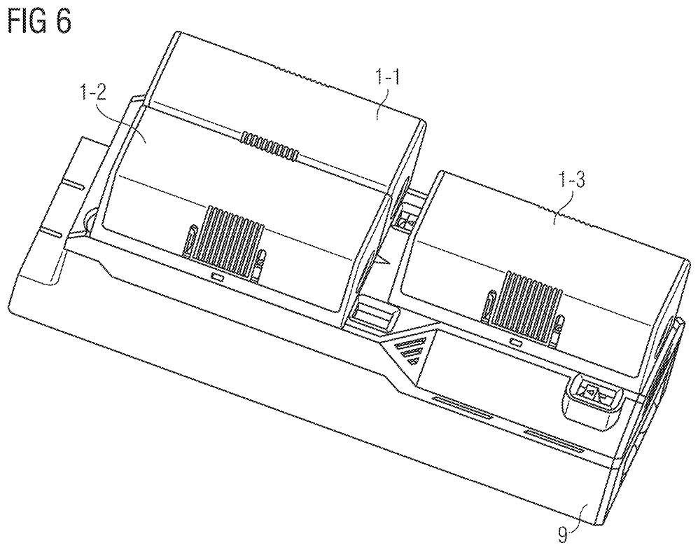

FIG. 6 illustrates different cube fuse adapters 1-1, 1-2, 1-3 plugged into an adapter device 9 of a power distribution system such as class CF cube fuse holder . Each of the cube fuse adapters 1-1, 1-2, 1-3 can include an inserted cylindrical fuse 5 as shown in FIG. 2. The cube fuse adapters 1-i can also be plugged into another kind of adapter devices such as cube fuse switches or into contact slots of power distribution crossboards with integrated power supply bars. The cylindrical fuses 5 inserted into the cube fuse adapters 1-i can provide overload protection and/or overcurrent protection within a power distribution or power supply system.

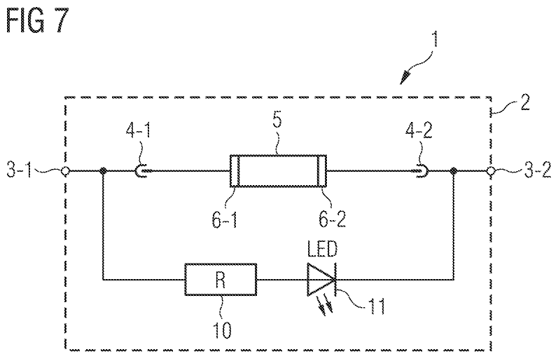

FIG. 7 shows a circuit diagram of a possible exemplary embodiment of a cube fuse adapter 1 according to the present invention. The adapter housing 2 of the cube fuse adapter 1 encloses a cylindrical fuse 5 having contact caps 6-1, 6-2 inserted into fuse reception contacts 4-1, 4-2. The fuse reception contacts 4-1, 4-2 are connected electrically to associated electrical contacts 3-1, 3-2 protruding from the adapter housing 2. In the illustrated embodiment of FIG. 5, a resistor 10 and a light emitting diode LED 11 are connected in series. The resistor 10 and the serial connected light emitting diode 11 are connected in parallel to the inserted electrical fuse 5 as shown in FIG. 5. In case that the electrical current flowing through the cylindrical fuse 5 is interrupted after the cylindrical fuse 5 has melted, the electrical current is redirected through the resistor 10 and the light emitting diode 11 which does emit light to indicate the interruption of the electrical current flow through the cylindrical fuse 5. The light emitting diode 11 can be located in a possible embodiment in the cover portion 2A of the cube fuse adapter housing 2. In this way, a user can be informed that the cylindrical fuse 5 within the housing 2 has melted and has to be replaced.

In a preferred embodiment, the resistor 10 comprises a high resistance to protect the light emitting diode 1 and to minimize the electrical current flowing from the first electrical contact 3-1 to the second electrical contact 3-2 in case that the cylindrical fuse 5 has melted and the current flow through the fuse has been interrupted. The light emitting diode 11 informs a user about the cause of the current interruption. For instance, if a load connected to the electrical contact 3-2 does not receive electrical supply current because the cylindrical fuse 5 within the adapter housing 2 has melted, the light emitting diode 11 emits light informing the user about the cause of the electrical current interruption. Other signaling components for indicating the electrical current interruption are possible, for instance an acoustic sound source emitting an acoustic warning signal in case that the cylindrical fuse 5 has melted due to an overcurrent or other reasons.

In a possible embodiment the interruption of the electrical current flowing through the cylindrical fuse in response to an overcurrent can be detected by a detector component integrated in the cube fuse adapter 1 and is signaled by the detector component via a third protruding electrical contact 3 to another device of the power distribution system.

In the embodiments illustrated in FIGS. 1 to 5, the cylindrical fuse 5 can be replaced after having removed the cover portion 2A from the base portion 2B of the adapter housing 2. Other embodiments of the cube fuse adapters 1 are possible. In a possible embodiment, the pair of fuse reception contacts 4-1, 4-2 is pivotable around a rotation axis between a first position where an inserted cylindrical fuse 5 is covered by the cover portion 2A of the adapter housing 2 and a second position where the inserted cylindrical fuse 5 is replaceable by a user.

In a further alternative embodiment, the cylindrical fuse 5 can also be inserted into the fuse reception contacts 4-1, 4-2 by pushing the cylindrical fuse 5 through a corresponding reception opening provided within the cover portion 2A of the adapter housing 2 in a lateral movement direction.

In a still further possible alternative embodiment of the cube fuse adapter 1, the cylindrical fuse 5 is first inserted into a corresponding fuse holding element such as a receiving cage. This fuse holding element can be pivotable around a rotation axis between a first position where the fuse holding element is enclosed by the adapter housing 2 and a second position where the fuse holding element and the inserted cylindrical fuse 5 are replaceable. In a still further possible alternative embodiment, the cylindrical fuse 5 inserted into the fuse holding element can be moved in a translation movement between a first position where the fuse holding element is enclosed by the adapter housing 2 and a second position where the fuse holding element and the inserted cylindrical fuse 5 are replaceable by a user.

The shape of the adapter housing 2 corresponds to the shape of a cube fuse. Accordingly, the adapter housing 2 can comprise different dimensions according to the corresponding dimensions of different types of cube fuses. The adapter housing 2 can be labeled as including a cylindrical fuse 5 which is replaceable. If the inserted cylindrical fuse 5 has melted or the configuration of the power distribution system, in particular the connected load, has changed, the inserted cylindrical fuse 5 can be easily replaced by another cylindrical fuse 5 matching the configuration requirements of the power distribution system.

1. A cube fuse adapter comprising:
an adapter housing shaped in the form of a cube fuse and including a pair of fuse reception contacts provided to receive a cylindrical fuse,
wherein said pair of fuse reception contacts are connected to associated electrical contacts protruding from a bottom side of the adapter housing of said cube fuse adapter, or
wherein each of said pair of fuse reception contacts forms an integral component with an associated electrical contact.

2. The cube fuse adapter according to claim 1 wherein:
the pair of fuse reception contacts are U-shaped, and
the cylindrical fuse includes, on opposite ends thereof, contact caps having a cylindrical outer surfaces configured for insertion into a corresponding U-shaped fuse reception contact and/or the cylindrical fuse includes end surfaces configured to be pressed between said pair of fuse reception contacts.

3. The cube fuse adapter according to claim 2 wherein each of said pair of fuse reception contacts includes two spaced apart contact arms facing each other and connected to each other by a contact base portion of the respective fuse reception contact.

4. The cube fuse adapter according to claim 3 wherein:
the contact base portion of the respective fuse reception contact is connected to an electrical contact protruding from the bottom side of the adapter housing of said cube fuse adapter, or
the contact base portion of the respective fuse reception contact forms an integral component with the associated electrical contact.

5. The cube fuse adapter according to claim 1 wherein the cylindrical fuse includes one of a class J fuse, a class CC fuse, a 14×51 fuse, a 22×58 fuse and a 10×38 fuse.

6. The cube fuse adapter according to claim 1 wherein the electrical contacts protruding from the bottom side of the adapter housing of said cube fuse adapter are pluggable into contact slots of a cube fuse holder or into contact slots of a cube fuse switch.

7. The cube fuse adapter according to claim 1 wherein a signaling component and a resistor are connected in series to a light emitting diode and are connected in parallel to the cylindrical fuse inserted into said pair of fuse reception contacts, wherein the signaling component is adapted to signal an interruption of an electrical current flow after the cylindrical fuse has melted due to an overcurrent.

8. The cube fuse adapter according to claim 1 wherein the adapter housing includes a cover portion removable from a base portion of the adapter housing.

9. The cube fuse adapter according to claim 8 wherein the cover portion and the base portion of the adapter housing include a fire resistant material and/or heat conductive material.

10. The cube fuse adapter according to claim 1 wherein the pair of fuse reception contacts is pivotable around a rotation axis between a first position in which an inserted cylindrical fuse is covered by the cover portion of the adapter housing and a second position in which the inserted cylindrical fuse is replaceable.

11. The cube fuse adapter according to claim 1 wherein the cylindrical fuse is configured to be inserted into the pair of fuse reception contacts by pushing the cylindrical fuse through a reception opening within the cover portion of the adapter housing.

12. The cube fuse adapter according to claim 1 wherein the pair of fuse reception contacts are externally sprung or self-sprung.

13. The cube fuse adapter according to claim 1 wherein the cylindrical fuse is inserted in a fuse holding element which is pivotable around a rotation axis or movable between a first position in which the fuse holding element is enclosed by the adapter housing and a second position in which the fuse holding element and the inserted cylindrical fuse are replaceable.

14. The cube fuse adapter according to claim 1 wherein the adapter housing is configured to provide at least an IP 20 enclosure protection.

15. The cube fuse adapter according to claim 1 wherein the adapter housing includes ventilation slots to provide heat dissipation.

16. A power distribution system comprising at least one cube fuse adapter having an adapter housing shaped in the form of a cube fuse and including a pair of fuse reception contacts provided to receive a cylindrical fuse, wherein both of the pair of fuse reception contacts are connected to associated electrical contacts protruding from a bottom side of the adapter housing of said cube fuse adapter or wherein each fuse reception contact of said pair of fuse reception contacts forms an integral component with an associated electrical contact, wherein the protruding electrical contacts of the cube fuse adapter are pluggable into corresponding slots of another device of said power distribution system.
